(19) United States
(12) Patent Application Publication
(10) Pub. No.: US 2011/0279512 A1
(43) Pub. Date: Nov. 17, 2011

(54) INKJET RECORDING DEVICE

(75) Inventors: Atsushi Kubota, Sunto-gun (JP); Masashi Hiroki, Yokohama-shi (JP); Satoshi Kaiho, Yokohama-shi (JP); Takashi Kado, Izunokuni-shi (JP); Kazuhiko Ohtsu, Mishima-shi (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/191,567

(22) Filed: Jul. 27, 2011

Related U.S. Application Data
(62) Division of application No. 12/210,403, filed on Sep. 15, 2008.
(60) Provisional application No. 60/976,118, filed on Sep. 28, 2007.

(51) Int. Cl. B41J 29/38

(52) U.S. Cl. 347/16

(57) ABSTRACT

The inkjet recording device has the feed mechanism for feeding the paper sheet in the feed direction, the inkjet head for ejecting the droplets towards the paper sheet conveyed by the feed mechanism, the dry section for drying the droplets attached on the paper sheet by landing, and the control mechanism for predicting the amount of heat necessary for drying the droplets based on either one of the paper sheet information of the paper sheet and the recording information to be recorded on the paper sheet to control the temperature of the dry section.

### CROSS-REFERENCE TO RELATED APPLICATIONS

This application is a Division of application Ser. No. 12/210,403 filed Sep. 15, 2008, which is based upon and claims the benefit of priority from U.S. Provisional application Ser. No. 60/976,118, filed Sep. 28, 2007, the entire contents of both of which are hereby incorporated herein by reference.

### TECHNICAL FIELD

The present invention relates to an inkjet recording device having an inkjet head.

### BACKGROUND

JP-A-4-135858 discloses an inkjet recording device which performs recording by ejecting ink from recording means to a paper sheet. This recording device has a heater for fixing the ink to the paper sheet, switching means for changing the drive condition of the fixing means, and detection means for detecting the posterior end of the paper sheet.

In this inkjet recording device, when the detection means detects the posterior end of the paper sheet, the detection means sends a switching signal to the switching means. The switching means raises the temperature of the heater in response to the signal. Thus, the ink in the posterior end of the paper sheet, which is not provided with enough time after printing, is promoted to dry.

Further, JP-A-2001-58398 discloses an inkjet recording device having a heater and cooling means. This inkjet recording device has a heater for drying the ink on the paper sheet, cooling means for preventing the paper sheet from burning, and control means for controlling the heater and the cooling means. In this inkjet recording device, the control means controls the temperature of the heater so that the temperature of the heater in the print standby condition becomes lower than the temperature of the heater in the print condition. Thus, the power consumption during the standby condition can be suppressed lower compared to the case of keeping the heater on standby at the temperature in the print condition.

However, in the inkjet recording device of the related art described above, since the drying process is uniformly executed by the heater regardless of the condition of printing, there is a possibility that the ink does not dry sufficiently depending on the condition of printing. If the paper sheets are stacked with the ink not sufficiently dried, there is a possibility that the paper sheets get stained.

### SUMMARY

An object of the invention is to provide an inkjet recording device capable of promoting the droplets to dry while keeping the simple structure.

In order for achieving the object described above, an inkjet recording device according to an aspect of the invention includes a feed mechanism for feeding a paper sheet in a feed direction, an inkjet head for ejecting a droplet towards the paper sheet conveyed by the feed mechanism, a dry section for drying the droplet attached to the paper sheet by landing, and a control mechanism for predicting an amount of heat necessary for drying the droplet based on either one of paper sheet information of the paper sheet and recording information to be recorded on the paper sheet to control temperature of the dry section.

In order for achieving the object described above, an inkjet recording device according to another aspect of the invention includes a feed mechanism for feeding a paper sheet in a feed direction, an inkjet head for ejecting a droplet towards the paper sheet conveyed by the feed mechanism, a dry section for drying the droplet attached to the paper sheet by landing, and a control mechanism for predicting drying time necessary for drying the droplet by the dry section based on either one of paper sheet information of the paper sheet and recording information to be recorded on the paper sheet to control a feeding speed of the feed mechanism.

In order for achieving the object described above, an inkjet recording device according to still another aspect of the invention includes an inkjet head for ejecting a droplet to a paper sheet, a drum having a cylindrical shape, and for receiving the droplet ejected by the inkjet head in a condition of absorbing the paper sheet on a periphery of the drum and making an idle revolution in the condition of absorbing the paper sheet after completion of the ejection of the droplet, a dry section for applying heat to the paper sheet absorbed by the drum, and a control mechanism for predicting drying time necessary for drying the droplet by the dry section based on either one of paper sheet information of the paper sheet and recording information to be recorded on the paper sheet to control a number of times of the idle revolution of the drum.

According to the invention, an inkjet recording device capable of promoting the droplets to dry while keeping the simple structure can be provided.

Objects and advantages of the invention will become apparent from the description which follows, or may be learned by practice of the invention.

### DESCRIPTION OF THE DRAWINGS

The accompanying drawings illustrate embodiments of the invention, and together with the general description given above and the detailed description given below, serve to explain the principles of the invention.

FIG. 1 is a schematic diagram showing an inkjet recording device according to a first embodiment.

FIG. 2 is a top view showing the condition of dividing the print area corresponding to the paper sheet into blocks in the inkjet recording device shown in FIG. 1.

FIG. 3 is a schematic diagram showing an inkjet recording device according to second and third embodiments.

FIG. 4 is a table chart for comparing paper sheets available to the user in Japan, North America, and Europe.

FIG. 5 is a schematic diagram showing an inkjet recording device according to a fourth embodiment.

FIG. 6 is a schematic diagram showing an inkjet recording device according to fifth and sixth embodiments.

FIG. 7 is a schematic diagram showing an inkjet recording device according to a seventh embodiment.

FIG. 8 is a schematic diagram showing an inkjet recording device according to eighth and ninth embodiments.

### DETAILED DESCRIPTION

The inkjet recording device according to the invention will hereinafter be explained with reference to the accompanying drawings. The inkjet recording device is capable of forming characters and graphics on a paper sheet by ejecting a liquid to the paper sheet.

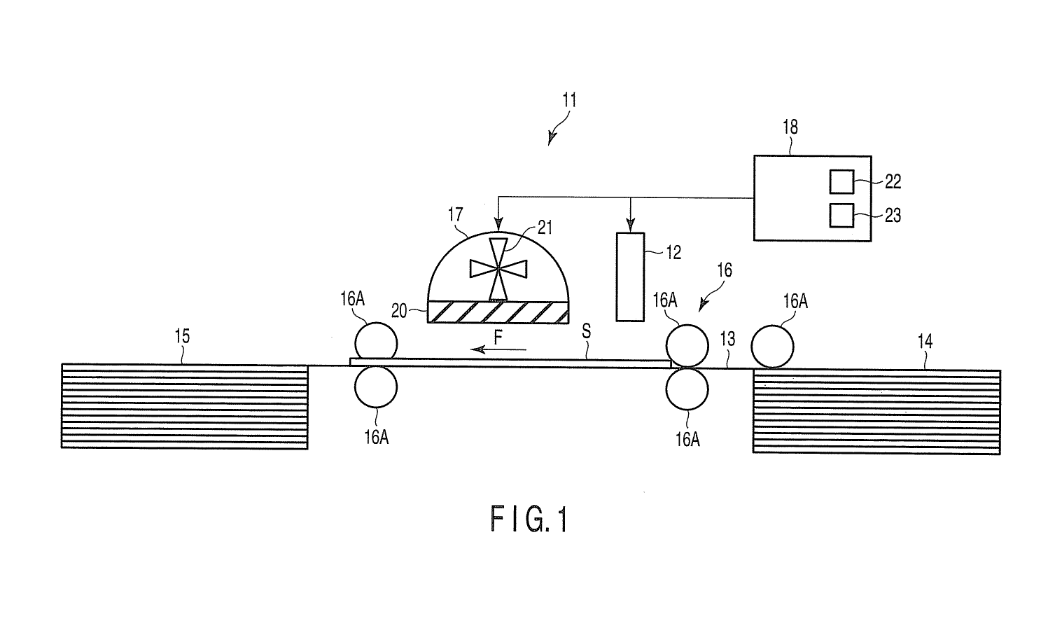

As shown in FIG. 1, the inkjet recording device 11 has an inkjet head 12 for ejecting droplets to a paper sheet S, a conveying path 13 through which the paper sheet S is conveyed, a paper feed section 14 for supplying the conveying path 13 with the paper sheet S, a paper discharge section 15 for collecting the paper sheet S having an image formed thereon from the conveying path 13, a feed mechanism 16 for feeding the paper sheet S on the conveying path 13 in a feed direction F, a dry section 17 for drying the droplets attached to the paper sheet S by landing, and a control mechanism 18 for integrally controlling the inkjet head 12, the feed mechanism 16, and the dry section 17.

The inkjet head 12 can eject droplets, namely ink droplets, to the paper sheet S fed by the feed mechanism 16. The inkjet head 12 has a plurality of nozzles, not shown, for ejecting ink. The inkjet head 12 has, for example, a piezoelectric element made of lead zirconium titanate (PZT) and functioning as a driver element. When applying a voltage to the piezoelectric element, the piezoelectric element is deformed to increase the pressure inside the pressure chamber corresponding to the nozzle. Thus, the droplet is ejected from the nozzle towards the paper sheet S.

The feed mechanism 16 has a plurality of drive rollers 16A for feeding the paper sheet S along the feed direction F. The dry section 17 has a Nichrome wire heater 20 and a fan 21 for sending the heat generated by the Nichrome wire heater 20 towards the paper sheet S. The dry section 17 is not limited to the configuration described above and may perform drying by using a microwave.

The control mechanism 18 not only controls driving of each section of the inkjet recording device 11, but also predicts the amount of heat necessary for drying the droplets based on the recording information to be recorded on the paper sheet S to control the temperature of the dry section 17. The control mechanism 18 has a discrimination section 22 for discriminating whether what is to be recorded on the paper sheet S is a character or a graphic based on the recording information, and a drive section 23 for controlling the temperature of the dry section 17 based on the discrimination result of the discrimination section 22. The drive section 23 makes the temperature of the dry section 17 become a first temperature when the recording information includes a graphic, and makes the temperature of the dry section 17 become a second temperature lower than the first temperature when the recording information includes only characters.

Incidentally, there are prepared the ink with respective colors such as black, yellow, magenta, and cyan as the ink ejected from the inkjet head 12 described above. The black ink has the composition as follows, for example.

Self-Dispersible Carbon Black Dispersion Liquid

| | | |
|---|---|---|
| (Concentration of the solid content of a | 8.0 | wt % |
| carbon black pigment) | | |
| Glycerine | 30.0 | wt % |
| Ethylene glycol monobutyl ether | 0.5 | wt % |
| Surfynol ®465 | 1.0 | wt % |
| Proxel ®XL-2(S) | 0.2 | wt % |

| | |
|---|---|
| Ion-exchanged water | the rest |

Further, the yellow ink has the composition as follows, for example.

Self-Dispersible Yellow Dispersion Liquid

| | | |
|---|---|---|
| (Concentration of the solid content of a | 6.0 | wt % |
| yellow pigment) | | |
| Glycerine | 45.0 | wt % |
| Ethylene glycol monobutyl ether | 5.0 | wt % |
| Surfynol ®465 | 1.0 | wt % |
| Proxel ®XL-2(S) | 0.2 | wt % |

| | |
|---|---|
| Ion-exchanged water | the rest |

The magenta ink has the composition as follows, for example.

Polymer Dispersant-Dispersed Magenta Dispersion Liquid

| | | |
|---|---|---|
| (Concentration of the solid content of a | 6.0 | wt % |
| magenta pigment) | | |
| Glycerine | 45.0 | wt % |
| Diethylene glycol monobutyl ether | 5.0 | wt % |
| Surfynol ®465 | 1.0 | wt % |
| Proxel ®XL-2(S) | 0.2 | wt % |

| | |
|---|---|
| Ion-exchanged water | the rest |

The cyan ink has the composition as follows, for example.

Polymer Dispersant-Dispersed Cyan Dispersion Liquid

| | | |
|---|---|---|
| (Concentration of the solid content of a | 6.0 | wt % |
| cyan pigment) | | |
| Glycerine | 45.0 | wt % |
| Triethylene glycol monobutyl ether | 5.0 | wt % |
| Surfynol ®465 | 1.0 | wt % |
| Proxel ®XL-2(S) | 0.2 | wt % |

| | |
|---|---|
| Ion-exchanged water | the rest |

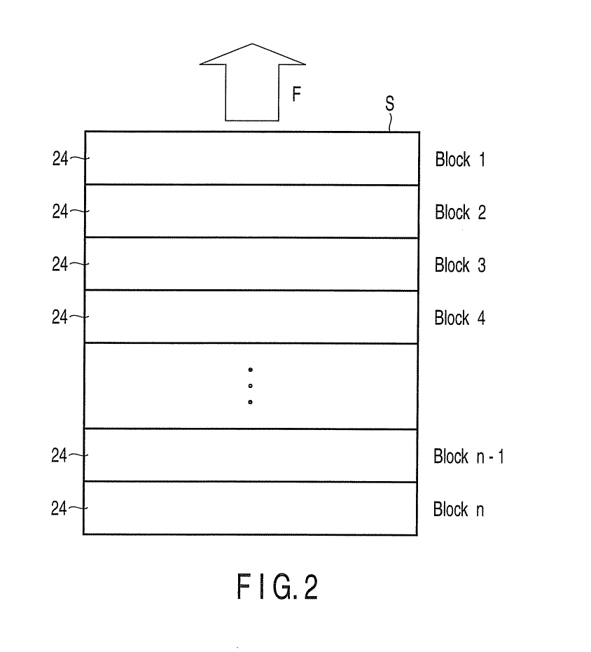

Subsequently, the image forming method used for the inkjet recording device 11 will be explained. Firstly, when sending the print information from the control mechanism 18 to the head driver, not shown, of the inkjet head 12, the discrimination section 22 acquires the print information to discriminate whether what is to be formed on the paper sheet S is a character or a graphic. In this occasion, as shown in FIG. 2, the discrimination section 22 divides the print area corresponding to the paper sheet S into a plurality of blocks 24 arranged in the feed direction F. The discrimination section 22 discriminates whether what is to be recorded on the paper sheet S is a character or a graphic in every block 24.

When the discrimination section 22 determines that what is to be recorded on the paper sheet S includes a graphic in the block 24, the drive section 23 makes the temperature of the dry section 17 become the first temperature, namely 130° C., when this block 24 passes by the dry section 17. When the discrimination section 22 determines that what is to be recorded on the paper sheet S includes only characters in the block 24, the drive section 23 makes the temperature of the dry section 17 become the second temperature, namely 110° C., when this block 24 passes by the dry section 17. Note that the inkjet recording device 11 has a sensor, not shown, for detecting the anterior end of the paper sheet S. The control mechanism 18 can figure out which block 24 on the paper sheet S is opposed to the dry section 17 by feeding the paper sheet S a predetermined distance from the position of the sensor via the feed mechanism 16.

According to the control described above, when printing a graphic which is predicted to require a large amount of heat for drying the droplets, the temperature of the dry section 17 rises. Therefore, the amount of heat applied to the paper sheet S becomes large. On the other hand, when printing a character or the like which predicted to require a small amount of heat for drying the droplets, the temperature of the dry section 17 drops. Therefore, the amount of heat applied to the paper sheet S becomes small. According to the control described above, appropriate heat is applied to the paper sheet S in accordance with the information recorded on the paper sheet S.

According to the first embodiment, the inkjet recording device 11 has the feed mechanism 16 for feeding the paper sheet S in the feed direction F, the inkjet head 12 for ejecting the droplets towards the paper sheet S conveyed by the feed mechanism 16, the dry section 17 for drying the droplets attached on the paper sheet S by landing, and the control mechanism 18 for predicting the amount of heat necessary for drying the droplets based on either one of the paper sheet information of the paper sheet S and the recording information to be recorded on the paper sheet S to control the temperature of the dry section 17.

Further, the control mechanism 18 has the determination section 22 for determining whether what is to be recorded on the paper sheet S is a character or a graphic based on the recording information, and the drive section 23 for making the temperature of the dry section 17 become the first temperature when the recording information includes a graphic, and making the temperature of the dry section 17 become the second temperature lower than the first temperature when the recording information includes only characters.

It is common that the recording density increases when forming a graphic such as a photograph on the paper sheet S, and the recording density decreases when forming a letter or a symbol on the paper sheet S. According to the configuration described above, the level of the recording density can easily be judged by discriminating whether what is to be formed on the paper sheet S is a character or a graphic. Thus, the amount of heat necessary for drying the droplets can accurately be predicted. Therefore, the droplets can appropriately be dried, thereby preventing the paper sheet S from being stained by the insufficiently dried droplets.

In this case, the discrimination section 22 divides the print area corresponding to the paper sheet S into the plurality of blocks 24 arranged in the feed direction thereof, and discriminates whether what is to be recorded on the paper sheet S in the block 24 is a character or a graphic, and the drive section 23 makes the temperature of the dry section 17 become the first temperature when this block 24 passes by the dry section 17 if it is determined that what is to be recorded on the paper sheet S in this block 24 includes a graphic, and makes the temperature of the dry section 17 become the second temperature when this block 24 passes by the dry section 17 if it is determined that what is to be recorded on the paper sheet S in this block 24 includes only characters.

According to the configuration described above, the temperature of the dry section 17 can be controlled in every block 24. Thus, more sophisticated temperature control can be performed in every block 24. Therefore, it can be prevented that too much heat is applied to the paper sheet S to cause the paper sheet S to be burnt.

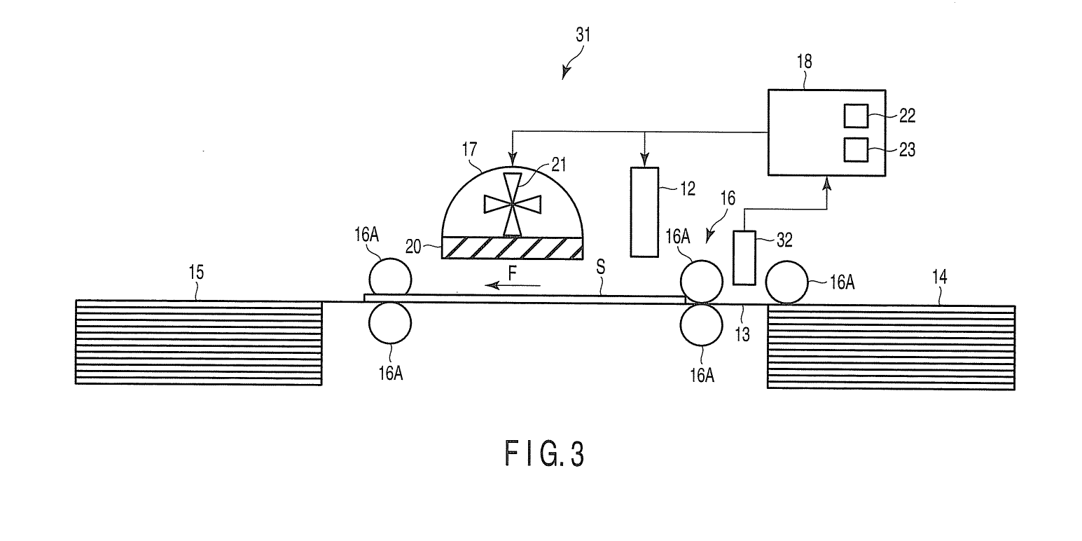

Subsequently, the inkjet recording device according to a second embodiment will be explained with reference to FIG. 3. The inkjet recording device 31 according to the second embodiment is different from that of the first embodiment in having a sensor 32 and in the configuration of the control mechanism 18, but has the other sections in common to that of the first embodiment. Therefore, the sections different from the first embodiment will mainly be explained, and the sections common to the first embodiment are denoted with the same reference numerals and the explanations therefor will be omitted.

The inkjet recording device 31 of the second embodiment has the sensor 32 for detecting the thickness of the paper sheet S conveyed on the conveying path 13 in addition to the configuration of that of the first embodiment.

The sensor 32 is formed, for example, of a laser displacement gauge. The sensor 32 can directly detect the thickness of the paper sheet S by emitting a laser beam towards the paper sheet S. The sensor 32 formed of the laser displacement gauge also detects a surface state of the paper sheet S. The sensor 32 detects a surface roughness of the paper sheet S. When the surface roughness is equal to or larger than a predetermined value, the control mechanism 18 determines that the paper sheet S is a special paper which is processed so as to easily fix ink thereon like a glossy paper. In this case, the control mechanism 18 allows the dry section 17 to become the second temperature. The control by the control mechanism 18 in this case is not limited thereto, and the control mechanism 18 may stop the drive of the dry section 17, or may stop the power supply to the Nichrome wire heater 20 so as to drive only a fan 21. When the surface roughness of the paper sheet S is less than the predetermined value, the control mechanism 18 determines that the paper sheet S is a plain paper. The control based on the surface roughness of the paper sheet S has priority to the control based on the detection of a thickness of the paper sheet S which is described later. That is, when the paper sheet S is determined as a special paper by means of such control, the control is performed as described above regardless of the thickness of the paper sheet S.

The control mechanism 18 has a discrimination section 22 for discriminating whether or not the thickness of the paper sheet S exceeds a predetermined threshold value, and the drive section 23 for controlling the temperature of the dry section 17.

Subsequently, the image forming method used for the inkjet recording device 31 will be explained. The discrimination section 22 firstly discriminates whether or not the thickness of the paper sheet S exceeds 100 μm taking 100 μm as the threshold value, for example. When the discrimination section 22 determines that the thickness of the paper sheet S detected by the sensor 32 exceeds 100 μm, the drive section 23 controls the temperature of the dry section 17 to be the first temperature, namely 130° C. Further, when the discrimination section 22 determines that the thickness of the paper sheet S is smaller than 100 μm, the drive section 23 controls the temperature of the dry section 17 to be the second temperature, namely 110° C.

Thus, the temperature of the dry section 17 becomes high with respect to the thick paper sheet S requiring a large amount of heat for drying the droplets. Thus, the amount of heat applied to the paper sheet S becomes large. On the other hand, with respect to the thin paper sheet S requiring only a small amount of heat for sufficiently drying the droplets, the temperature of the dry section 17 becomes low. Thus, the amount of heat applied to the paper sheet S becomes small. According to the control described above, appropriate heat is applied to the paper sheet S in accordance with the thickness of the paper sheet S.

Note that although in the present embodiment the threshold value of the thickness of the paper sheet S is set to 100 μm, and the two levels of temperature of the dry section 17 are prepared, it is also possible to set two threshold values of the thickness of the paper sheet S and three levels of temperature of the dry section 17.

According to the second embodiment, the control mechanism 18 has the discrimination section 22 for discriminating whether or not the thickness of the paper sheet S exceeds a predetermined threshold value, and the drive section 23 for making the temperature of the dry section 17 become the first temperature when it is determined that the thickness of the paper sheet S exceeds the threshold value while making the temperature of the dry section 17 become the second temperature when it is determined that the thickness of the paper sheet S is smaller than the threshold value.

Whether or not the heat is efficiently conducted to the droplets attached to the paper sheet S by landing thereon depends on how easily the paper sheet S on which the droplets land is heated, namely the thermal capacity of the paper sheet S. The thermal capacity of the paper sheet S is proportional to the thickness of the paper sheet S. According to the configuration described above, it is possible to predict the amount of heat necessary for drying the droplets based on the thickness of the paper sheet S as the paper sheet information of the paper sheet S to vary the temperature of the dry section 17. Thus, with respect to the thick paper sheet S requiring a large amount of heat for drying the droplets, it is possible to make the temperature of the dry section 17 high to make the amount of heat applied to the paper sheet S large. Further, with respect to the thin paper sheet S not requiring a large amount of heat for drying the droplets, it is possible to make the temperature of the dry section 17 low to prevent the amount of heat applied to the paper sheet S from becoming too large. Thus, it is possible to efficiently dry the droplets by appropriately controlling the amount of heat applied to the paper sheet S.

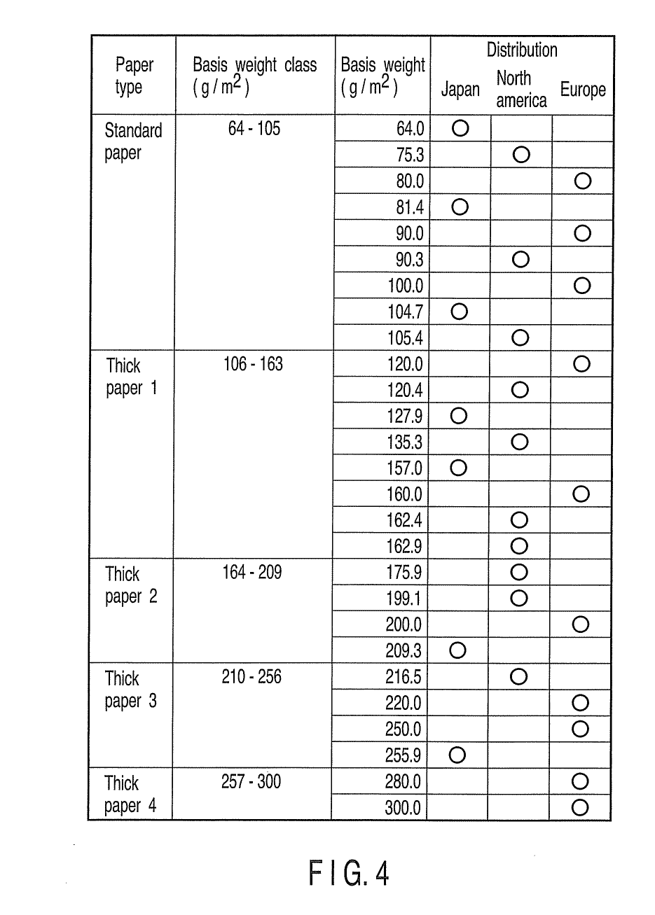

Subsequently, the inkjet recording device according to a third embodiment will be explained with reference to FIGS. 3 and 4. The inkjet recording device 31 according to the third embodiment is different from that of the second embodiment in discriminating the paper sheet S based on the weight of the paper sheet S, but has the other sections in common to that of the second embodiment. Therefore, the sections different from the second embodiment will mainly be explained, and the sections common to the second embodiment are denoted with the same reference numerals and the explanations therefor will be omitted.

The control mechanism 18 has the discrimination section 22 for discriminating whether or not the basis weight of the paper sheet S exceeds a predetermined threshold value, and the drive section 23 for controlling the temperature of the dry section 17. The basis weight denotes the weight of the paper sheet S per unit area.

Subsequently, the image forming method used for the inkjet recording device 31 will be explained. The discrimination section 22 firstly calculates the basis weight (g/m²) of the paper sheet S, which is the weight thereof per unit area, by multiplying the thickness value of the paper sheet S detected by the sensor 32 by the value of the density of the paper sheet S measured previously. Further, the discrimination section 22 discriminates whether or not the basis weight of the paper sheet S exceeds 120 g/m² taking 120 g/m² as the threshold value. Note that the threshold value is determined based on the table chart shown in FIG. 4. Further, when it is determined that the basis weight of the paper sheet S exceeds 120 g/m², the drive section 23 controls the temperature of the dry section 17 to be the first temperature, namely 130° C. Further, when it is determined that the basis weight of the paper sheet S is lower than 120 g/m², the drive section 23 controls the temperature of the dry section 17 to be the second temperature, namely 110° C.

Thus, the temperature of the dry section 17 becomes high with respect to the heavy and thick paper sheet S requiring a large amount of heat for drying the droplets. Thus, the amount of heat applied to the paper sheet S becomes large. On the other hand, with respect to the light and thin paper sheet S requiring only a small amount of heat for sufficiently drying the droplets, the temperature of the dry section 17 becomes low. Thus, the amount of heat applied to the paper sheet S becomes small. According to the control described above, appropriate heat is applied to the paper sheet S in accordance with the basis weight of the paper sheet S.

Note that although in the present embodiment the threshold value of the basis weight of the paper sheet S is set to 120 g/m², and the two levels of temperature of the dry section 17 are prepared, it is also possible to set two threshold values of the basis weight of the paper sheet S and three levels of temperature of the dry section 17.

According to the third embodiment, the control mechanism 18 has the discrimination section 22 for discriminating whether or not the basis weight of the paper sheet S exceeds a predetermined threshold value, and the drive section 23 for making the temperature of the dry section 17 become the first temperature when it is determined that the basis weight of the paper sheet S exceeds the threshold value while making the temperature of the dry section 17 become the second temperature when it is determined that the basis weight of the paper sheet S is lower than the threshold value.

Whether or not the heat is efficiently conducted to the droplets attached to the paper sheet S by landing thereon depends on how easily the paper sheet S on which the droplets land is heated, namely the thermal capacity of the paper sheet S. The thermal capacity of the paper sheet S is proportional to the basis weight of the paper sheet S. According to the configuration described above, it is possible to predict the amount of heat necessary for drying the droplets based on the basis weight of the paper sheet S as the paper sheet information of the paper sheet S to vary the temperature of the dry section 17. Thus, with respect to the thick paper sheet S requiring a large amount of heat for drying the droplets, it is possible to make the temperature of the dry section 17 high. Further, with respect to the thin paper sheet S not requiring a large amount of heat for drying the droplets, it is possible to prevent the temperature of the dry section 17 from becoming too high. Thus, it is possible to efficiently dry the droplets by appropriately controlling the amount of heat applied to the paper sheet S.

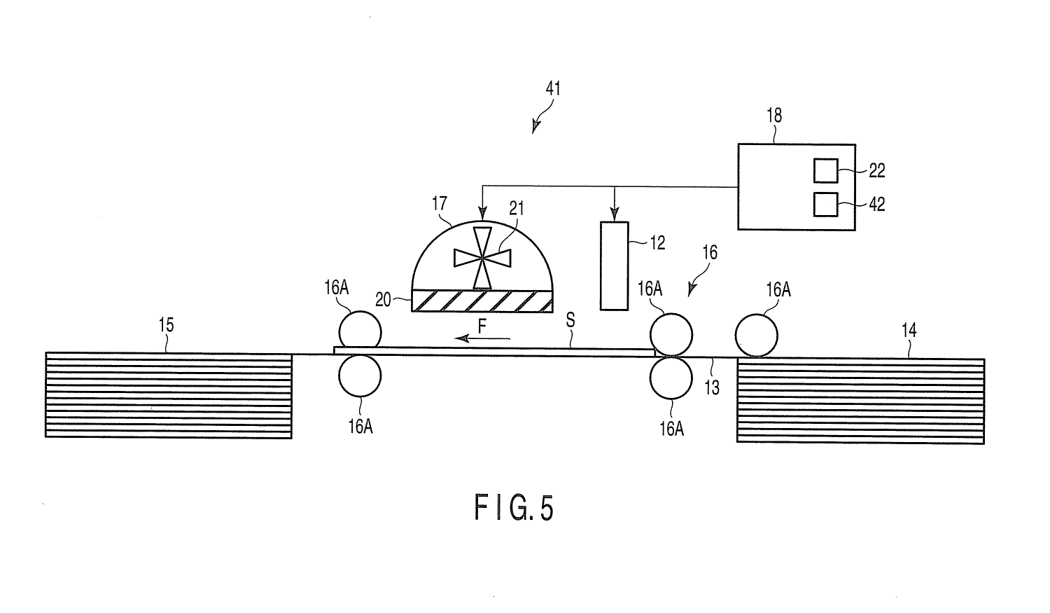

Subsequently, the inkjet recording device according to a fourth embodiment will be explained with reference to FIG. 5. The inkjet recording device 41 according to the fourth embodiment is different from that of the first embodiment in that the control mechanism 18 has a speed control section 42 for controlling the feeding speed of the paper sheet S by the feed mechanism 16, but has the other sections common to that of the first embodiment. Therefore, the sections different from the first embodiment will mainly be explained, and the sections common to the first embodiment are denoted with the same reference numerals and the explanations therefor will be omitted.

As shown in FIG. 5, the inkjet recording device 41 has the inkjet head 12 for ejecting droplets to the paper sheet S, the conveying path 13 through which the paper sheet S is conveyed, the paper feed section 14 for supplying the conveying path 13 with the paper sheet S, the paper discharge section 15 for collecting the paper sheet S having an image formed thereon from the conveying path 13, the feed mechanism 16 for feeding the paper sheet S on the conveying path 13 in the feed direction F, the dry section 17 for drying the droplets attached to the paper sheet S by landing, and the control mechanism 18 for integrally controlling the inkjet head 12, the feed mechanism 16, and the dry section 17.

The dry section 17 is the same as that in the first embodiment. Note, however, that the dry section 17 according to the present embodiment is different from that of the first embodiment in that the temperature thereof is constant. The temperature of the dry section 17 is set to, for example, 110° C.

The control mechanism 18 not only controls driving of each section of the inkjet recording device 41, but also predicts the drying time necessary for drying the droplets by the dry section 17 based on the recording information to be recorded on the paper sheet S. The control mechanism 18 has the discrimination section 22 for discriminating whether what is to be formed on the paper sheet S with the droplets is a character or a graphic, and the speed control section 42 for controlling the feeding speed of the feed mechanism 16.

The image forming method used for the inkjet recording device 41 will be explained. When sending the print information from the control mechanism 18 to the head driver, not shown, of the inkjet head 12, the discrimination section 22 acquires the print information to discriminate whether what is to be recorded on the paper sheet S is a character or a graphic.

The speed control section 42 reduces the feeding speed of the feed mechanism 16 to a first speed when the discrimination section 22 determines that what is to be recorded on the paper sheet S is a graphic. Further, the speed control section 42 makes the feeding speed of the feed mechanism 16 become a second speed, namely the normal feeding speed when the discrimination section 22 determines that what is to be recorded on the paper sheet S is a character. The first speed is the feeding speed, which is, for example, 50% of the second speed, namely the normal feeding speed.

Thus, the feeding speed by the feed mechanism 16 is lowered when printing a graphic predicted to take longer drying time necessary for drying the droplets. Thus, the dry section 17 applies the heat to the droplets for a long period of time. On the other hand, when printing characters or the like predicted to take shorter drying time necessary for drying the droplets, the feeding speed by the feed mechanism 16 increases. Therefore, the dry section 17 applies the heat to the droplets for only a short period of time. According to the control described above, an appropriate drying time is set in accordance with how easily the droplets are dried.

According to the fourth embodiment, the inkjet recording device 41 has the feed mechanism 16 for feeding the paper sheet S in the feed direction F, the inkjet head 12 for ejecting the droplets towards the paper sheet S conveyed by the feed mechanism 16, the dry section 17 for drying the droplets attached on the paper sheet S by landing, and the control mechanism 18 for predicting the drying time necessary for drying the droplets by the dry section 17 based on either one of the paper sheet information of the paper sheet S and the recording information to be recorded on the paper sheet S to control the feeding speed of the feed mechanism 16.

Further, the control mechanism 18 has the determination section 22 for determining whether what is to be recorded on the paper sheet S is a character or a graphic based on the recording information, and the speed control section 42 for making the feeding speed of the feed mechanism 16 become the first speed when the recording information includes a graphic, and making the feeding speed of the feed mechanism 16 become the second speed higher than the first speed when the recording information includes only characters.

Typically, when forming graphics such as photographs on the paper sheet S, the recording density becomes high, which requires longer time for drying the droplets. On the other hand, when forming characters, symbols, or the like on the paper sheet S, the recording density becomes low, which allows the droplets to dry in a short period of time. According to the configuration described above, the level of the recording density can easily be judged by discriminating whether what is to be recorded on the paper sheet S is a character or a graphic. Thus, it becomes possible to appropriately set the drying time of the droplets by manipulating the feeding speed of the paper sheet S.

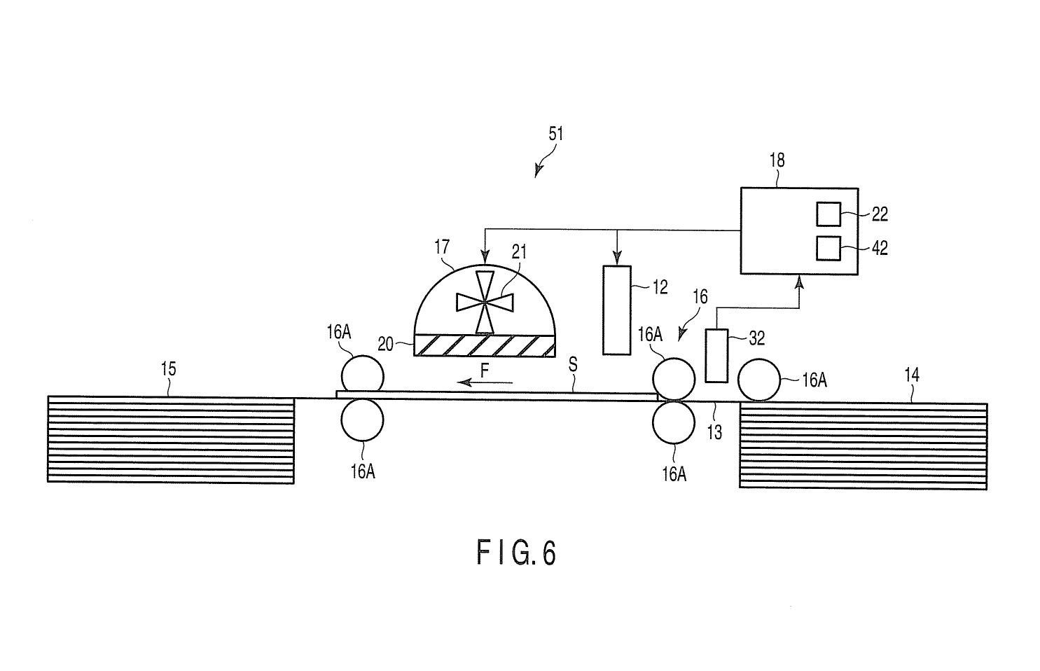

Subsequently, the inkjet recording device according to a fifth embodiment will be explained with reference to FIG. 6. The inkjet recording device 51 according to the fifth embodiment is different from that of the fourth embodiment in having a sensor 32 and in the configuration of the control mechanism 18, but has the other sections in common to that of the fourth embodiment. Therefore, the sections different from the fourth embodiment will mainly be explained, and the sections common to the fourth embodiment are denoted with the same reference numerals and the explanations therefor will be omitted.

The inkjet recording device 51 of the fifth embodiment has the sensor 32 for detecting the thickness of the paper sheet S conveyed on the conveying path 13 in addition to the configuration of that of the fourth embodiment. The sensor 32 is formed, for example, of a laser displacement gauge. The sensor 32 can directly detect the thickness of the paper sheet S using a laser beam.

The control mechanism 18 has the discrimination section 22 for discriminating whether or not the thickness of the paper sheet S exceeds a predetermined threshold value, and the speed control section 42 for controlling the feeding speed of the feed mechanism 16.

The image forming method used for the inkjet recording device 51 will be explained. The discrimination section 22 firstly discriminates whether or not the thickness of the paper sheet S exceeds 100 μm taking 100 μm as the threshold value, for example. When it is determined that the thickness of the paper sheet S detected by the sensor 32 exceeds 100 μm, the speed control section 42 makes the feeding speed of the feed mechanism 16 become the feeding speed of, for example, 50% of the normal feeding speed. Further, when it is determined that the thickness of the paper sheet S is smaller than 100 μm, the feeding speed of the feed mechanism 16 is made become the normal feeding speed.

Thus, the feeding speed of the paper sheet S by the feed mechanism 16 becomes low with respect to the thick paper sheet S requiring a large amount of heat for drying the droplets. Thus, the paper sheet S is exposed to the dry section 17 for a long period of time, and the amount of heat applied to the paper sheet S becomes large. On the other hand, with respect to the thin paper sheet S requiring only a small amount of heat for sufficiently drying the droplets, the feeding speed of the paper sheet S by the feed mechanism 16 becomes high. Thus, the paper sheet S is exposed to the dry section 17 for only a short period of time, and the amount of heat applied to the paper sheet S becomes small.

Note that although in the present embodiment the threshold value of the thickness of the paper sheet S is set to 100 μm, and the two levels of feeding speed are prepared, it is also possible to set two threshold values of the thickness of the paper sheet S and three levels of feeding speed of the feed mechanism 16.

According to the fifth embodiment, the control mechanism 18 has the discrimination section 22 for discriminating whether or not the thickness of the paper sheet S exceeds a predetermined threshold value, and the speed control section 42 for making the feeding speed of the feed mechanism 16 become the first speed when it is determined that the thickness of the paper sheet S exceeds the threshold value while making the feeding speed of the feed mechanism 16 become the second speed higher than the first speed when it is determined that the thickness of the paper sheet S is smaller than the threshold value.

According to the configuration described above, it is possible to predict the amount of heat necessary for drying the droplets based on the thickness of the paper sheet S as the paper sheet information of the paper sheet S to control the feeding speed of the paper sheet S, thereby varying the amount of heat applied to the paper sheet S. Thus, with respect to the thick paper sheet S requiring a longer period of time for drying the droplets, it is possible to make the drying time of the paper sheet S longer by decreasing the feeding speed of the paper sheet. Further, with respect to the thin paper sheet S not requiring a long period of time for drying the droplets, it is possible to make the drying time of the paper sheet S shorter by increasing the feeding speed of the paper sheet S. Thus, it is possible to efficiently dry the droplets by appropriately controlling the drying time of the paper sheet S.

Subsequently, the inkjet recording device according to a sixth embodiment will be explained with reference to FIGS. 4 and 6. The inkjet recording device 51 according to the sixth embodiment is different from that of the fifth embodiment in discriminating the paper sheet S based on the basis weight of the paper sheet S, but has the other sections in common to that of the fifth embodiment. Therefore, the sections different from the fifth embodiment will mainly be explained, and the sections common to the fifth embodiment are denoted with the same reference numerals and the explanations therefor will be omitted.

The control mechanism 18 has the discrimination section 22 for discriminating whether or not the basis weight of the paper sheet S exceeds a predetermined threshold value, and the speed control section 42 for controlling the feeding speed of the feed mechanism 16.

The image forming method used for the inkjet recording device 51 will be explained. The discrimination section 22 calculates the basis weight (g/m²) of the paper sheet S, which is the weight thereof per unit area, by multiplying the thickness value of the paper sheet S detected by the sensor 32 by the value of the density of the paper sheet S measured previously. Further, the discrimination section 22 discriminates whether or not the basis weight of the paper sheet S exceeds 120 g/m² taking 120 g/m² as the threshold value, for example. Note that the threshold value is determined based on the table chart shown in FIG. 4. When it is determined that the basis weight of the paper sheet S exceeds 120 g/m², the speed control section 42 makes the feeding speed of the feed mechanism 16 become the feeding speed of, for example, 50% of the normal feeding speed. Further, when it is determined that the basis weight of the paper sheet S is lower than 120 g/m², the feeding speed of the feed mechanism 16 is made become the normal feeding speed.

Thus, the feeding speed of the paper sheet S by the feed mechanism 16 becomes low with respect to the heavy paper sheet S requiring a large amount of heat for drying the droplets. Thus, the paper sheet S is exposed to the dry section 17 for a long period of time, and the amount of heat applied to the paper sheet S becomes large. On the other hand, with respect to the light paper sheet S requiring only a small amount of heat for sufficiently drying the droplets, the feeding speed of the paper sheet S by the feed mechanism 16 becomes high. Thus, the paper sheet S is exposed to the dry section 17 for only a short period of time, and the amount of heat applied to the paper sheet S becomes small. According to the control described above, appropriate heat is applied to the paper sheet S in accordance with the basis weight of the paper sheet S.

Note that although in the present embodiment the threshold value of the basis weight of the paper sheet S is set to 120 g/m², and the two levels of feeding speed are prepared, it is also possible to set two threshold values of the basis weight of the paper sheet S and three levels of feeding speed.

According to the sixth embodiment, the control mechanism 18 has the discrimination section 22 for discriminating whether or not the basis weight of the paper sheet S exceeds a predetermined threshold value, and the speed control section 42 for making the feeding speed of the feed mechanism 16 become the first speed when it is determined that the basis weight of the paper sheet S exceeds the threshold value while making the feeding speed of the feed mechanism 16 become the second speed higher than the first speed when it is determined that the basis weight of the paper sheet S is lower than the threshold value.

According to the configuration described above, it is possible to predict the drying time necessary for drying the droplets based on the basis weight of the paper sheet S as the paper sheet information of the paper sheet S to vary the feeding speed of the paper sheet S. Thus, the amount of heat applied to the paper sheet S can be varied. Therefore, with respect to the heavy paper sheet S requiring a longer period of time for drying the droplets, it is possible to make the drying time of the paper sheet S longer by decreasing the feeding speed of the paper sheet S. Further, with respect to the light paper sheet S not requiring a long period of time for drying the droplets, it is possible to make the drying time of the paper sheet S shorter by increasing the feeding speed of the paper sheet S. Thus, it is possible to efficiently dry the droplets by appropriately controlling the drying time of the paper sheet S.

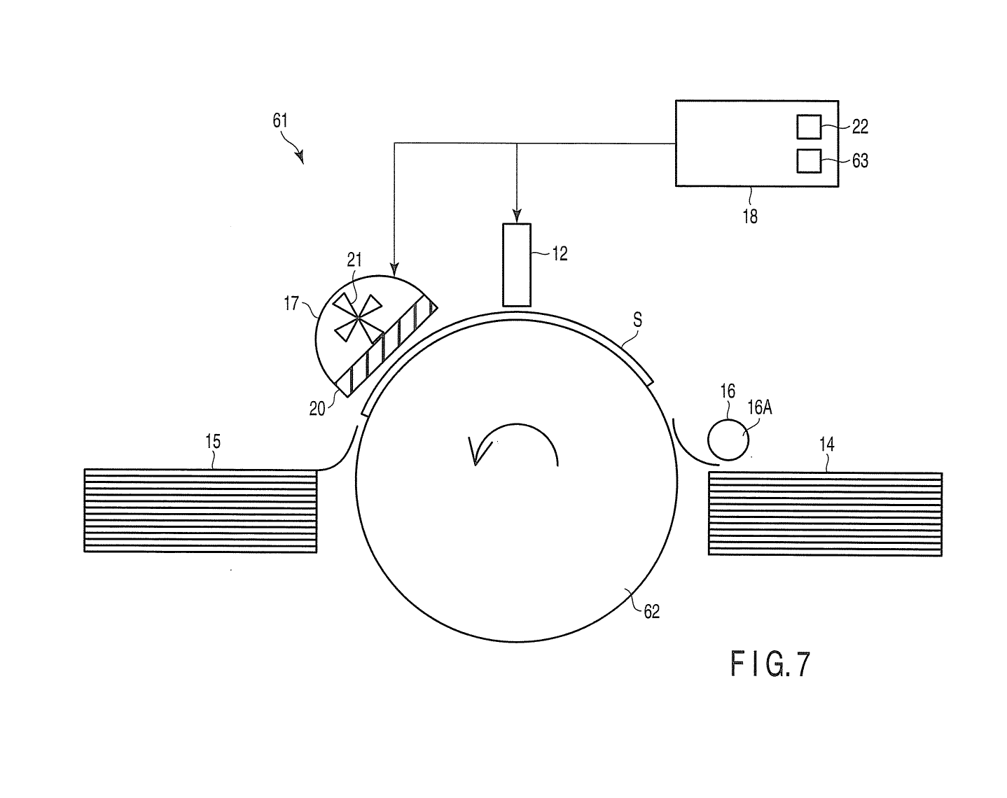

Subsequently, the inkjet recording device according to a seventh embodiment will be explained with reference to FIG. 7. The inkjet recording device 61 according to the seventh embodiment is different from that of the fourth embodiment in having a drum 62 for absorbing the paper sheet S instead of the conveying path 13, but has the other sections in common to that of the fourth embodiment. Therefore, the sections different from the fourth embodiment will mainly be explained, and the sections common to the fourth embodiment are denoted with the same reference numerals and the explanations therefor will be omitted. As shown in FIG. 7, the inkjet recording device 61 has the inkjet head 12 for ejecting droplets to the paper sheet S, the drum 62 having a cylindrical shape and for absorbing the paper sheet S, the paper feed section 14 for supplying the drum 62 with the paper sheet S, the paper discharge section 15 for collecting the paper sheet S having an image formed thereon from the drum 62, the feed mechanism 16 for feeding the paper sheet S from the paper feed section 14 to the drum 62, the dry section 17 for drying the droplets attached to the paper sheet S by landing, and the control mechanism 18 for integrally controlling the inkjet head 12, the drum 62, the feed mechanism 16, and the dry section 17. The inkjet head 12, which is substantially the same as that in the first embodiment, is capable of ejecting the droplets to the paper sheet S absorbed to the drum 62. The drum 62 can make idle revolutions in the direction indicated by the arrow in the condition of absorbing the paper sheet S after completion of the ejection of the droplets.

The dry section 17 is substantially the same as that in the first embodiment, and is disposed at the position opposed to the drum 62. Note, however, that the dry section 17 according to the present embodiment is different from that of the first embodiment in that the temperature thereof is constant. The temperature of the dry section 17 is set to, for example, 110° C. The drum 62 is connected to a suction mechanism, not shown, capable of suctioning the surface thereof to absorb the paper sheet S on the surface. The drum 62 is not limited to the suction type, but can be, for example, an electrostatic type for absorbing the paper sheet S using electrostatic force.

The control mechanism 18 not only controls driving of each section of the inkjet recording device 61, but also predicts the drying time necessary for drying the droplets by the dry section 17 based on the recording information to be recorded on the paper sheet S. The control mechanism 18 has the discrimination section 22 for discriminating whether what is to be formed on the paper sheet S with the droplets is a character or a graphic, and a drum drive section 63 for controlling the rotation of the drum 62.

The image forming method used for the inkjet recording device 61 will be explained. When sending the print information from the control mechanism 18 to the head driver, not shown, of the inkjet head 12, the discrimination section 22 acquires the print information to discriminate whether what is to be formed on the paper sheet S is a character or a graphic.

The drum drive section 63 makes the drum 62 make a predetermined number of times of the idle revolution, for example, one idle revolution when the discrimination section 22 determines that what is to be recorded on the paper sheet S includes a graphic. Further, the drum drive section 63 eliminates the idle revolution of the drum 62 when the discrimination section 22 determines that what is to be recorded on the paper sheet S includes only characters. Note that the number of times of the idle revolution of the drum 62 is not limited to one, but can be set so as to make a plurality of times of the idle revolution.

Thus, when printing a graphic predicted to require the longer drying time for drying the droplets, the idle revolutions of the drum are performed while the drum absorbs the paper sheet S. Thus, the heat is applied to the droplets on the paper sheet S by the dry section 17 for a long period of time. On the other hand, when printing a character or the like predicted to require the shorter drying time for drying the droplets, the idle revolution of the drum 62 is eliminated. Therefore, the dry section 17 applies the heat to the droplets for only a short period of time. According to the control described above, an appropriate drying time is set in accordance with how easily the droplets are dried.

According to the seventh embodiment, the inkjet recording device 61 has the inkjet head 12 for ejecting the droplets to the paper sheet S, the drum 62 having the cylindrical shape for receiving the droplets ejected from the inkjet head 12 while absorbing the paper sheet on the periphery thereof and making idle revolutions while keeping the paper sheet S absorbed thereon after completion of the ejection of the droplets, the dry section 17 for applying the heat to the paper sheet S absorbed to the drum 62, and the control mechanism 18 for predicting the drying time necessary for drying the droplets by the dry section 17 based on either one of the paper sheet information of the paper sheet S and the recording information to be recorded on the paper sheet S to control the number of times of the idle revolutions of the drum 62.

Further, the control mechanism 18 has the discrimination section 22 for discriminating whether what is to be recorded on the paper sheet S is a character or a graphic based on the recording information, and the drum drive section 63 for making the drum 62 make the predetermined number of times of the idle revolution when the recording information includes a graphic, and for eliminating the idle revolution of the drum 62 when the recording information includes only characters.

Typically, when forming graphics such as photographs on the paper sheet S, the recording density becomes high, which requires longer time for drying the droplets. On the other hand, when forming characters, symbols, or the like on the paper sheet S, the recording density becomes low, which allows the droplets to dry in a short period of time. According to the configuration described above, the level of the recording density can easily be judged by discriminating whether what is to be recorded on the paper sheet S is a character or a graphic. Thus, it becomes possible to easily adjust the drying time for the droplets by manipulating presence or absence of the idle revolution of the drum 62.

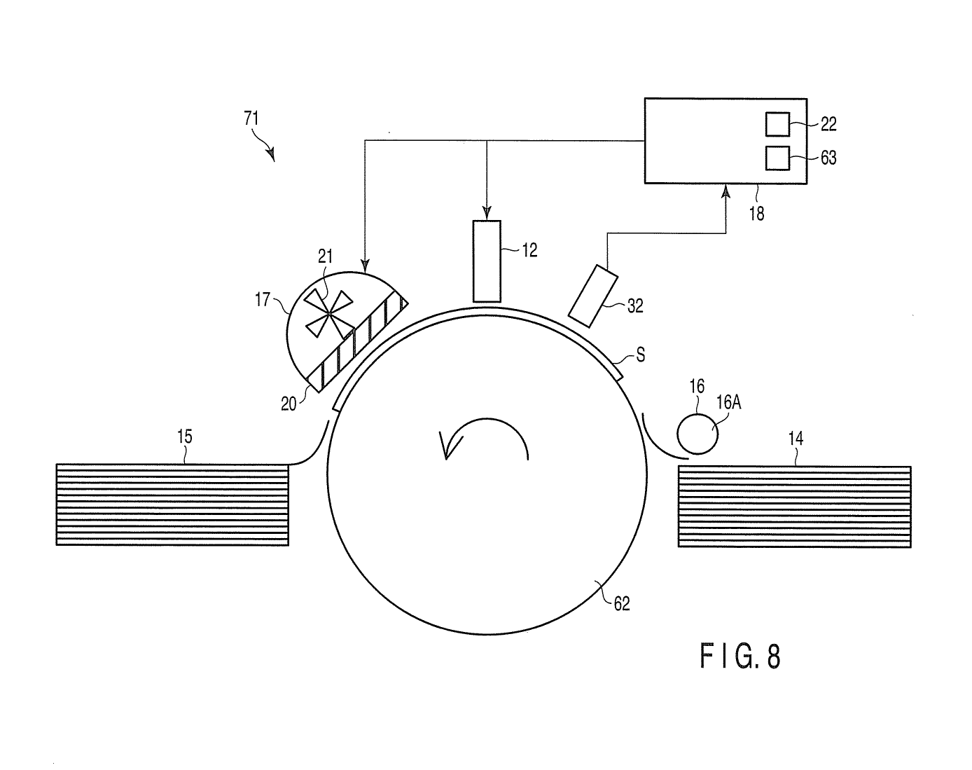

Subsequently, the inkjet recording device according to an eighth embodiment will be explained with reference to FIG. 8. The inkjet recording device 71 according to the eighth embodiment is different from that of the seventh embodiment in having a sensor 32 and in the configuration of the control mechanism, but has the other sections in common to that of the seventh embodiment. Therefore, the sections different from the seventh embodiment will mainly be explained, and the sections common to the seventh embodiment are denoted with the same reference numerals and the explanations therefor will be omitted.

The inkjet recording device 71 of the eighth embodiment has the sensor 32 for detecting the thickness of the paper sheet S absorbed by the drum 62 in addition to the configuration of that of the seventh embodiment.

The sensor 32 is formed, for example, of a laser displacement gauge. The sensor 32 can directly detect the thickness of the paper sheet S using a laser beam.

The control mechanism 18 has a discrimination section 22 for discriminating whether or not the thickness of the paper sheet S exceeds a predetermined threshold value, and the drum drive section 63 for driving the rotation of the drum 62.

The image forming method used for the inkjet recording device 71 will be explained. The discrimination section 22 firstly discriminates whether or not the thickness of the paper sheet S exceeds 100 μm taking 100 μm as the threshold value, for example. When it is determined that the thickness of the paper sheet S detected by the sensor 32 exceeds 100 μm, the drum drive section 63 makes the drum 62 make a predetermined number of times of the idle revolution, for example, one idle revolution. Further, when it is determined that the thickness of the paper sheet S is smaller than 100 μm, the drum drive section 63 eliminates the idle revolution of the drum 62.

Thus, with respect to the thick paper sheet S predicted to require the longer drying time for drying the droplets, the drum 62 makes the idle revolution. Thus, the paper sheet S is exposed to the dry section 17 for a long period of time, and the amount of heat applied to the paper sheet S becomes large. On the other hand, with respect to the thin paper sheet S requiring only a small amount of heat for sufficiently drying the droplets, the idle revolution of the drum 62 is eliminated. Thus, the paper sheet S is exposed to the dry section 17 for only a short period of time, and the amount of heat applied to the paper sheet S becomes small. According to the control described above, an appropriate drying time is set in accordance with how easily the droplets are dried.

Note that although in the present embodiment the threshold value of the thickness of the paper sheet S is set to 100 μm, and presence or absence of the idle revolution of the drum 62 is determined, it is also possible to set two threshold values of the thickness of the paper sheet S and three levels of the number of times of the idle revolution of the drum 62, for example, no idle revolution, one idle revolution, and three idle revolutions.

According to the eighth embodiment, the control mechanism 18 has the discrimination section 22 for discriminating whether or not the thickness of the paper sheet S exceeds a predetermined threshold value, and the drum drive section 63 for making the drum 62 make the predetermined number of times of the idle revolution when it is determined that the thickness of the paper sheet S exceeds the threshold value while eliminating the idle revolution of the drum 62 when it is determined that the thickness of the paper sheet S is smaller than the threshold value.

According to the configuration described above, it is possible to predict the drying time necessary for drying the droplets based on the thickness of the paper sheet S as the paper sheet information of the paper sheet S to control presence or absence of the idle revolution of the drum 62, thereby varying the drying time of the droplets. Thus, with respect to the thick paper sheet S requiring a longer period of time for drying the droplets, it is possible to make the drying time of the paper sheet S longer by performing the idle revolution of the drum 62. Further, with respect to the thin paper sheet S not requiring a longer period of time for drying the droplets, it is possible to make the drying time of the paper sheet S shorter by eliminating the idle revolution of the drum 62. Thus, it becomes possible to easily adjust the drying time for the droplets by manipulating presence or absence of the idle revolution of the drum 62.

Subsequently, the inkjet recording device according to a ninth embodiment will be explained with reference to FIGS. 4 and 8. The inkjet recording device 71 according to the ninth embodiment is different from that of the eighth embodiment in discriminating the paper sheet S based on the basis weight of the paper sheet S, but has the other sections in common to that of the eighth embodiment. Therefore, the sections different from the eighth embodiment will mainly be explained, and the sections common to the eighth embodiment are denoted with the same reference numerals and the explanations therefor will be omitted.

The control mechanism 18 has a discrimination section 22 for discriminating whether or not the thickness of the paper sheet S exceeds a predetermined threshold value, and the drum drive section 63 for driving the rotation of the drum 62.

The image forming method used for the inkjet recording device 71 will be explained. The discrimination section 22 calculates the basis weight (g/m²) of the paper sheet S, which is the weight thereof per unit area, by multiplying the thickness value of the paper sheet S detected by the sensor 32 by the value of the density of the paper sheet S measured previously. Further, the discrimination section 22 discriminates whether or not the basis weight of the paper sheet S exceeds 120 g/m² taking 120 g/m² as the threshold value, for example. When it is determined that the basis weight of the paper sheet S exceeds 120 g/m², the drum drive section 63 makes the drum 62 make a predetermined number of times of the idle revolution, for example, one idle revolution. Further, when it is determined that the basis weight of the paper sheet S is lower than 120 g/m², the idle revolution of the drum 62 is eliminated.

Thus, with respect to the heavy paper sheet S predicted to require the longer drying time for drying the droplets, the drum 62 makes the idle revolution. Thus, the paper sheet S is exposed to the dry section 17 for a long period of time, and the amount of heat applied to the paper sheet S becomes large. On the other hand, with respect to the light paper sheet S requiring only a small amount of heat for sufficiently drying the droplets, the idle revolution of the drum 62 is eliminated. Thus, the paper sheet S is exposed to the dry section 17 for only a short period of time, and the amount of heat applied to the paper sheet S becomes small. According to the control described above, an appropriate drying time is set in accordance with how easily the droplets are dried.

Note that although in the present embodiment the threshold value of the basis weight of the paper sheet S is set to 120 g/m², and presence or absence of the idle revolution of the drum 62 is determined, it is also possible to set two threshold values of the basis weight of the paper sheet S and three levels of the number of times of the idle revolution of the drum 62, for example, no idle revolution, one idle revolution, and three idle revolutions.

According to the ninth embodiment, the control mechanism 18 has the discrimination section 22 for discriminating whether or not the basis weight of the paper sheet S exceeds a predetermined threshold value, and the drum drive section 63 for making the drum 62 make the predetermined number of times of the idle revolution when it is determined that the basis weight of the paper sheet S exceeds the threshold value while eliminating the idle revolution of the drum 62 when it is determined that the basis weight of the paper sheet S is lower than the threshold value.

According to the configuration described above, it is possible to predict the drying time necessary for drying the droplets based on the basis weight of the paper sheet S as the paper sheet information of the paper sheet S to control presence or absence of the idle revolution of the drum 62. Thus, the drying time for the droplets can be varied. Thus, with respect to the heavy paper sheet S requiring a longer period of time for drying the droplets, it is possible to make the drying time of the paper sheet S longer by performing the idle revolution of the drum 62. Further, with respect to the light paper sheet S not requiring a longer period of time for drying the droplets, it is possible to make the drying time of the paper sheet S shorter by eliminating the idle revolution of the drum 62. Thus, it becomes possible to easily adjust the drying time for the droplets by manipulating presence or absence of the idle revolution of the drum 62.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inkjet recording device comprising:
a feed mechanism for feeding a paper sheet in a feed direction;
an inkjet head for ejecting a droplet towards the paper sheet conveyed by the feed mechanism;
a dry section for drying the droplet attached to the paper sheet by landing; and
a control mechanism for controlling temperature of the dry section based on either one of paper sheet information of the paper sheet and recording information to be recorded on the paper sheet.

2. The device according to claim 1,
wherein the control mechanism includes
a discrimination section for discriminating whether what is to be recorded on the paper sheet is a character or a graphic based on the recording information, and
a speed control section for making the feeding speed of the feed mechanism become a first speed in response to the recording information including a graphic, and making the feeding speed of the feed mechanism become a second speed higher than the first speed in response to the recording information including only characters.

3. The device according to claim 1,
wherein the control mechanism includes
a discrimination section for discriminating whether or not a thickness of the paper sheet exceeds a predetermined threshold value, and
a speed control section for making the feeding speed of the feed mechanism become a first speed in response to determination that the thickness of the paper sheet exceeds the threshold value, and making the feeding speed of the feed mechanism become a second speed higher than the first speed in response to determination that the thickness of the paper sheet is smaller than the threshold value.

4. The device according to claim 1,
wherein the control mechanism includes
a discrimination section for discriminating whether or not weight of the paper sheet exceeds a predetermined threshold value, and
a speed control section for making the feeding speed of the feed mechanism become a first speed in response to determination that the weight of the paper sheet exceeds the threshold value, and making the feeding speed of the feed mechanism become a second speed higher than the first speed in response to determination that the weight of the paper sheet is lower than the threshold value.

5. An inkjet recording device comprising:
an inkjet head for ejecting a droplet to a paper sheet;
a drum having a cylindrical shape, and for receiving the droplet ejected by the inkjet head in a condition of absorbing the paper sheet on a periphery of the drum and making an idle revolution in the condition of absorbing the paper sheet after completion of the ejection of the droplet;
a dry section for applying heat to the paper sheet absorbed by the drum; and
a control mechanism for controlling a number of times of the idle revolution of the drum based on paper sheet information of the paper sheet.

6. The device according to claim 5,
wherein the control mechanism includes
a discrimination section for discriminating whether or not a thickness of the paper sheet exceeds a predetermined threshold value, and
a drum drive section for making the drum make a predetermined number of times of the idle revolution in response to determination that the thickness of the paper sheet exceeds the threshold value, and eliminating the idle revolution of the drum in response to determination that the thickness of the paper sheet is smaller than the threshold value.

7. The device according to claim 5,
wherein the control mechanism includes
a discrimination section for discriminating whether or not weight of the paper sheet exceeds a predetermined threshold value, and
a drum drive section for making the drum make a predetermined number of times of the idle revolution in response to determination that the weight of the paper sheet exceeds the threshold value, and eliminating the idle revolution of the drum in response to determination that the weight of the paper sheet is lower than the threshold value.

8. An inkjet recording device comprising:
an inkjet head for ejecting a droplet to a paper sheet;
a drum having a cylindrical shape, and for receiving the droplet ejected by the inkjet head in a condition of absorbing the paper sheet on a periphery of the drum and making an idle revolution in the condition of absorbing the paper sheet after completion of the ejection of the droplet;
a dry section for applying heat to the paper sheet absorbed by the drum; and
a control mechanism for controlling a number of times of the idle revolution of the drum based on recording information.

9. The device according to claim 8,
wherein the control mechanism includes
a discrimination section for discriminating whether what is to be recorded on the paper sheet is a character or a graphic based on the recording information, and
a drum drive section for making the drum make a predetermined number of times of the idle revolution in response to the recording information including a graphic, and eliminating the idle revolution of the drum in response to the recording information including only characters.
